(19) United States
(12) Patent Application Publication
(10) Pub. No.: US 2010/0104850 A1
(43) Pub. Date: Apr. 29, 2010

(54) Masonry Product and Method of Manufacture

(75) Inventor: Kerry Bennett, New South Wales (AU)

Correspondence Address: AKERMAN SENTERFITT, P.O. BOX 3188, WEST PALM BEACH, FL, 33402-3188, US

(73) Assignee: Benex Technologies Pty Ltd, Orange New South Wales (AU)

(21) Appl. No.: 12/531,008

(22) PCT Filed: Mar. 13, 2008
(86) PCT No.: PCT/AU2008/000357

§ 371 Date: Nov. 25, 2009

(30) Foreign Application Priority Data
Mar. 13, 2007 (AU) 2007901291

(51) Int. Cl. B32B 3/26; C08J 9/36

(52) U.S. Cl. 428/313.5; 521/146

(57) ABSTRACT

A method of forming and mixing a Portland cement based material incorporating expanded styrene beads with a liquid surfactant being added at the time of mixing the Portland cement and other ingredients. As well there is described a masonry product with expanded styrene beads and air bubbles distributed through the product with rehydrated Portland cement crystals distributed as aligned crystals located around the beads and other materials.

This invention relates to a masonry product, a method of effecting a useful wet cement mixture for application to a product and to a method of manufacture of a masonry product.

### BACKGROUND OF THE INVENTION

The use of Portland cement in its various forms is well known. The characteristics of the various Portland cements have been widely explored.

Portland cement is manufactured by grinding clinker which is then used by adding water so that the ground material rehydrates and in doing so, form a plurality of crystalline like structures (ettringite) which are conventionally randomly disposed one with respect to the other.

A majority of the rehydrated material originating perhaps from calcium silicates within the clinker will form crystalline structures either early stage ettringite type 1 or later stage ettringite type 2.

The physical characteristics therefore of the product are defined by the characteristics expected from interlocking crystal shapes which are generally joined by mechanical interlocking.

Conventional Portland cement based masonry products in many cases have therefore traditionally a low tensile strength, are relatively permeable to water and have relatively low resistance to higher temperatures for instance fire rating.

A conventional dry compressed concrete block, of which very large numbers indeed are currently being manufactured, have these general characteristics.

There would be value if at least some of these characteristics could be improved.

It is an object of this invention to propose in one instance a masonry product that has some advantages over that currently being manufactured and used, and it also directed to a method which can be used together with selected ingredients which can provide for a Portland cement based masonry product having improved characteristics.

### DISCLOSURE OF THE INVENTION

In one form of this invention which may not be the only or indeed the broadest form of this there is proposed a masonry product having a plurality of polystyrene beads substantially uniformly distributed through a matrix of closed cells provided by walls of hydrated Portland cement, where each of the beads is substantially separated one from the other but distributed so that the concentration is such that at least in the main the beads are separated by a distance that is approximately equal to or less than a width of a most of the beads in the immediate vicinity of the bead space to be assessed, the hydrated crystals forming a complete surround or substantially complete surround around at least a majority of the beads, and the material between the beads being at least in the main an arrangement of closed cells defined by further hydrated crystals encompassing for each cell, an air bubble.

In preference the size at least in the main of a most of the air bubbles is less than 0.5 mms in diameter.

In preference the crystalline structure defining the wall for each cell includes at least in the main aligned crystals.

The invention arises from a discovery that in some circumstances, there can be effected a rehydration crystallisation from Portland cement where there is caused to be in an aligned form, crystals packing in more or less parallel alignment to form a plurality of substantially casings. If a primary material of a mixture including a significant proportion of Portland cement provides a crystallisation triggering material and these are formed into separate cellular structures with an anionic surfactant or there are miniature bubbles of air having also a sulphur containing surfactant extending around each surface then there does appear to be the advantage of this invention.

An anionic surfactant may have an hydrophilic end where the hydrophiles can be the carboxylates (soaps), sulphates, sulphonates and phosphates. In this case, the hydrophilic end of the surfactant is strongly attracted to the water molecules and the force of attraction between the hydrophobe and water is only slight. As a result, the surfactant molecules align themselves at the surface and internally so that the hydrophile end is toward the water and the hydrophobe is squeezed away from the water. It is our thought that it is this hydrophobe end that acts to trigger the ettringite crystal formation.

It seems that there is provided thereby for each end a catalyst to trigger the formation in an epitaxial direction to a water film an ettringite crystal. By having these crystals caused to be aligned more or less parallel one to the other and being closely adjacent each other means that there is therefore a packed skin or casing around the source of the trigger. These then would seem to form where ever there is such a water/film and by being epitaxially aligned to the film surface means that these then will form as a hard skin along the film surface. By having a plurality of distributed materials which can support the attachment of the water with the surfactant.

A resultant structure achieved by selection of relative quantities of material including water, surfactant and Portland cement can be such that there can be as an end result, a plurality of thin walled separated cells substantially distributed through the material.

This is achieved by supplying the mixing Portland cement and styrene beads with at least water and surfactant either together or separately in liquid form as a part of the mixing process. Once added this starts the crystal formation as described to form these hard casings and there is then a limited time after which the material will set and of course can no longer be mixed as such.

It can be arranged that the cells providing a preliminary or primary substructure are closed cell and that the inner surface or skin of each cell is formed to follow the shape of each cell as it hardens.

By forming a closed cell structure which can be described as a plurality of hard skins defining each cell and these being spaced in a distributed manner through the mixture so that there is an underlying matrix of the structure which is comprised of such hard Waits, means that the nature of this individual skin or cell wall is replicated throughout the whole product and therefore provides an essentially or substantially impermeable material.

Further, however, because the strong cell walls form a good interconnected base structure but not interconnected by mutual openings, one into the other, this then offers some higher flexibility in so far that the approximately spherical shape of each cell wall can be slightly deformed without fracturing.

Further, by effecting a range of different cell sizes there can be larger cells and smaller cells filling between interces with smaller cell sizes which would otherwise be open to be interconnected by the hard casing but not by interconnecting of the spaces themselves, that there is a cellular structure that can provide quite significant advantageous characteristics to a product thus formed.

In this invention, we have used beads of foamed plastic which are embedded within the Portland cement matrix. Such beads are chosen to have a preferable size defining at least most of larger cells formed and aeration causes bubbles to form which have a size that enables a packing to occur between the larger cells.

Others have attempted to incorporate beads of expanded or foamed plastic for instance polystyrene beads previously but have not been able to achieve characteristics of the current invention.

Hitherto, it is known that others have attempted to achieve a masonry product by pretreating polystyrene beads with a coating that is then dried and is then used in the dry state to be directly added to a Portland cement mixture.

Such a previous system has advantages in so far that the treatment can ensure that the beads once coated with this alternate material, can be integrated into a Portland cement mixture but there have been two problems with this, namely, it is costly to additionally handle polystyrene to effect a coating and then treat the further product as a product to be purchased and integrated into mixing of Portland cement.

A second problem however apart from cost is that any resultant product results in the polystyrene beads simply acting as a simple aggregate and having no other effect, as far as we are aware of anyway, in relation to the mixing or hardening stages of Portland cement and implicitly not forming the hard casings.

The advantage of the known system is that there is an aggregate of lighter weight than say conventional gravels but for reasons that we perhaps now understand slightly better, there has been no major improvement in the insulation characteristics, fire rating, flexural strength or permeability of the resultant material.

In accordance with this invention, we have found that by using polystyrene material in particulate form as it might be supplied either from original manufacturers or from recyclers, and putting this directly into the cementitious mixture of Portland cement, will normally mean that the untreated particles will not mix adequately with the Portland cement and will also effect a floating to the surface so that it becomes effectively impossible to distribute such material uniformly through the mixture and of course any resultant product, not having uniformly distributed polystyrene as an additive, has no additional value.

We have found that by adding a liquid additive namely a surfactant to the wet Portland cement mixture or by adding the surfactant to the water to be added, and then either before or after wards adding the polystyrene particulates, can result in the particulates integrating fully and easily throughout the full mixture.

In other words the invention could be said to reside in the method of effecting a cement mix which includes the steps of adding to a Portland cement and aggregate including expanded styrene beads, water and a surfactant in liquid form at the time of mixing, then mixing the mixture until the ingredients are distributed relatively uniformly through the mix.

The quantity of light weight aggregate is such that there can be a resultant density which will lie in preference in the range of weight per cubic metre=900 kgcubic metre to 1500 kg/cubic metre.

A preferred density after the mix has set and cured is weight/m3=1000 kg/m3. The figures below are based on the proposed range of 900 kg/m3 to 1500 kg/m3.

In preference there is provided sand which can within the range be from 401 kg to 673 kg/m3 which can be sourced from beach through to river sand, including crushed sandstone but generally so that the sand is a fine sand.

Portland cement as a dry powder 341 kg to 568/m3.

Polystyrene (based on a range of weight and size of bead) weight range 12 kg/m3 to 20 kg/m3, size 2-6 mm in diameter. Volume/m3=548 It to 913 It/m3

Water 119 It to 198 It.

Surfactant in liquid form clear, 2.08 It to 3.1 It. The surfactant is obtained as a commercially supplied product and is currently used in the form as supplied by a commercial supplier under a recognised Trade Mark in Australia in this case Bycol. Other commercially available surfactants which are useful have been found to be Vespol and Clearcol.

The ranges are given so that a lighter or heavier mix can be made and the proportion of the ingredients chosen accordingly. The quantity of water has to be judged so that it is not in excess in the mixture and may vary because of the specific Portland cement used, the dilution of the surfactant, the wetness of the sand and even the temperature at which the materials are to be mixed.

The invention can also reside in a product as a result of this method.

Further, once in a mixture with the selected additive and the expanded styrene particles perhaps because of mutual repulsion offered by the attached surfactant the particles will distribute themselves during a mixing process relatively uniformly throughout the mix.

This is especially beneficial in order to get a high ratio by volume of polystyrene as compared to Portland cement.

Further however, by use of a selected additive or additives into the mixing of the Portland cement, there can also be caused during a selected mixing, a plurality of micro bubbles within the mixture.

It is known that there are additives that can be used to promote such aeration but it is a feature of this arrangement that this is used in conjunction with polystyrene beads which are on the whole of larger diameter than air bubbles that are also caused in conjunction with a mixing.

The mixture and additives are selected so that the bubble size is generally smaller than the diameter of at least larger styrene particulates but are also in preference below 0.5 mm in diameter.

If the styrene is in the form of beads of 1 to 4 mm in diameter, then we have an arrangement in which the air bubbles of various sizes, but generally not bigger than 0.5 mm in diameter will infill between the larger but kept separate by polystyrene beads.

The addition of a product known generally as a plasticiser has been found to be beneficial and in one preferred case we have used a superplasticiser (Glenium 51) and as supplied by the commercial supplier in the above mix 1.1 It to 1.9 It. This material when mixed into the mixture forms what can be described as liquid ball bearings. These are small bubbles which when combined with the other ingredients provide this additional effect of having these hard casings form.

It can be of value to also accelerate a set and cure of the mixture and a conventional ingredient such as Calcium Chloride 2.8 It to 4.7 It has been found to be useful. If the ambient temperature goes over 28 degrees, the mix may set too quickly. Therefore the range could be from zero to 4.7 It.

Now the unique thing that happens here is that by selecting the appropriate quantity of Portland cement and having this in a wet form as compared to a dry compressed form, means that most of the cement structure that will now be formed follows and defines thin walls between either bubbles of air or somewhat larger cells defined by polystyrene beads.

Then as an initial mixture is a structure in which some of the Portland cement is held as liquid but rapidly hydrating crystals probably of ettringite, is distributed and grows as epitaxial directed long crystals being relatively thin interconnecting liquid films defining closed cells with closely packed parallel aligned crystals.

Now we have found that once we have this structure, the Portland cement divides itself into early and late setting components where alite is a fast setting material crystallising probably where there is most water which will be at the surface either of the bubbles or of the surface of the cell shape defined by the polystyrene surface and further, by having an additive such as an appropriate surfactant and in this case preferably sulphur containing, effects a triggering of the elite where this is consistently triggered over a continuous surface and therefore such alite crystals grow coherently or in an aligned manner packed close to each other and forming this hard surface shell.

Later hardening materials of Portland cement will form behind such early growth crystals, perhaps in the form of belite but by careful selection of the total quantity of Portland cement and water we have most of the body of the eventual material in the form of thin walls with at least a portion being these closely packed strongly interconnecting crystal structures which provide beneficial strength both in tension and compression, some flexure capacity and also an extent of impermeability that has not hitherto been generally realised with Portland cement based masonry products.

We are aware that there are various forms of Portland cement and in trials conducted so far, it does appear that all of the conventional forms of Portland cement will follow the same structural system.

Additives that can provide surface triggering effect which also assist in the distribution of polystyrene beads can be purchased and are generally sold under commercial trade marks for instance one form of this is known as the Trade Mark Bycol, and another is known as Vinsol which can be bought from Hercules.

In a further form the invention can be said to reside in a masonry product having a plurality of polystyrene beads distributed through a matrix of hydrated Portland cement, where each of the beads is substantially separated one from the other but distributed so that the concentration is such that at least in the main the beads are separated by a distance that is approximately equal to or less than a width of a most of the beads in the immediate vicinity of the bead space to be assessed, the hydrated crystals forming a complete surround or substantially complete surround around at least a majority of the beads, and the material between the beads being at least in the main an arrangement of closed cells defined by further hydrated crystals encompassing for each cell an air bubble.

In preference the size at least in the main of a most of the air bubbles is less than 0.5 mms (perhaps 1 mm).

In further preference the crystalline structure defining the wall for each cell includes at least in the main aligned crystals.

I will now describe the mixture and method of achieving a masonry product in accordance with these discoveries.

An advantage of any resultant product is that it can also be handled in ways which are similar to timber for instance, it can be readily and can be sawn, it provides in its preferred embodiment an ability to hold taps or anchors and because it has a relatively high flexural capacity and strength, a variety of products can be formed which rely upon these characteristics.

Further, with these characteristics, if blocks for building purposes are made, it has advantage where the blocks are independently glued together using a cementitious adhesive and even cemented on to a common foundation so that the whole structure then has a structural integrity which can be of significant advantage in many applications.

It is not intended that this description should limit the discovery to blocks but it is well understood that this mixture and basic internal structure which can be achieved in several different ways can be used hereinafter for a number of different purposes for instance for making complete panels, for provision of roof or ceiling tiles, for manufacture of boat hulls or for any marine application where the ability to float on water is of advantage and where impermeability to water is highly desirable.

Further, however, integrated structures for instance the whole of the walls, ceiling and floor of a bathroom could be integrally moulded from material according to this invention and using this internal structure.

### BEST MODE FOR CARRYING OUT THE INVENTION

We now, however, will describe the specific steps for the manufacture and the materials that we have found to be our best mode in achieving this so far.

It is not intended in the broader sense to limit the method or the resulting products to any specific materials for instance, it is known that various forms of expanded lightweight material can be used although to date polystyrene has been found to be an ideal material and especially when selected to have for instance 4 mm maximum diameter but having smaller particles incorporated.

### EXAMPLE 1

Mix quantities specifically for a A60 Block 600 mm×200 mm high×100 mm thick
Sand (crushed sandstone from Lithgow NSW) 5.387 kg per block
Portland Cement (off white, by Blue Circle) 4.55 kg per block
Expanded Polystyrene Beads of mixed sizes (from 0.5 mm to 4 mm diameter with density approximately 20-25 kg per m3)-7.31 Zit per block
Water clean soft 1.59 It per block
Bycol (clear) 25 ml per block
Superplasticiser (Glenium 51 by Degussa)(polycarboxylate superplasticizer) 15.25 ml per block
   GLENIUM 51 is an admixture based on modified polycarboxylic ether.

Calcium Chloride 37.5 ml per block

### Mixing Procedure

A 120 It Pan Mixer enough mix for 8×A60 blocks.
Start the mixer
Pour as a first step all of the otherwise untreated and uncoated polystyrene beads into the mixer
Then add the sand and cement
Then add the water with the chemicals in the water just before the mix starts with the air entrainer and surfactants Bycol and Superplasticiser being put into the mix before the calcium chloride
   Note: The mixer will continue without any changes for approximately 3 min
Stop the mixer
The amount of time needed to cure the blocks is almost entirely dependant on the ambient temperature. In the cold winters of Orange, New South Wales it can take up to 8-9 hours to have the block dried enough to strip them from the moulds, where as in the heat of the summer, it might only take 5 hours.

Trials conducted so far have shown that the material resulting from the method described provides a masonry material which once set and allowed to cure for 7 days provides a material that is in terms of water imperviousness in the form of a block as described and when tested from front face to rear face the test being in accord with Australian standards testing exhibited negligible transfer of water therethrough through the 24 hour trial according.

Again using a wail consisting of blocks as described and subjecting this to a standard fire rating test as prescribed in Australia for load bearing conditions the fire rating was in excess of a three hour rating.

As such the material is considered to be of preferred value in a number of applications where conventional concrete has hitherto been inappropriate. For explanation the following describes Portland cement for the purposes of this specification. Portland cement clinker is an hydraulic material which consists of at least two-thirds by mass of calcium silicates (3CaO.SiO₂ and 2CaO.SiO₂), the remainder consisting of aluminium- and iron-containing clinker phases and other compounds. The ratio of CaO to SiO₂ is not less than 2.0. The magnesium content (MgO) does not exceed 5.0% by mass. Portland cement clinker is made by heating, in a kiln, an homogeneous mixture of raw materials to a sintering temperature, which is about 1450° C. for modern cements which is then ground to a powder. Aluminium oxide and iron oxide are present as a flux and contribute little to the strength. Some of the secondary raw materials used are: clay, shale, sand, iron ore, bauxite, fly ash and slag. When a cement kiln is fired by coal, the ash of the coal becomes a secondary raw material.

Specific details given are not intended to limit the invention to such details.

1. A masonry product having a structure comprising
a plurality of expanded plastics beads substantially uniformly distributed with each of at least most of the beads being encased within a wall of hydrated Portland cement crystals aligned with substantially parallel axes to provide a closed cell thereby,
where each of the beads is substantially separated one from the other but distributed so that the distribution is such that at least in the main the beads are separated by a distance that is approximately equal to or less than a width of a most of the beads in the immediate vicinity of the bead space to be assessed, the hydrated crystals forming a complete surround or substantially complete surround around at least a majority of the beads, and the material between the beads being at least in the main an arrangement of closed cells defined by further hydrated crystals encompassing for each cell, an air bubble.

2. The masonry product as in claim 1, wherein the size of at least most of the air bubbles is less than 0.5 mm in diameter.

3. The masonry product as in claim 1, wherein the expanded plastics material is expanded polystyrene.

4. The masonry product as in claim 1, in which there is also included sand particles as a substantial constituent.

5. The masonry product as in claim 1, wherein the product is result of a primary material of a mixture including the expanded polystyrene beads and a significant proportion of Portland cement with a rehydration triggering material surrounding at least the separate beads with an anionic surfactant and miniature bubbles of air having also a sulphur containing surfactant extending around each surface.

6. (canceled)

7. The masonry product as in claim 5, wherein the anionic surfactant has a hydrophilic end where the hydrophiles are selected from any one of the carboxylates, sulphates, sulphonates and phosphates, the hydrophilic end of the surfactant being strongly attracted to water molecules, and a hydrophobic end, wherein the force of attraction between a hydrophobic end and water is only slight, whereby the surfactant molecules align themselves at water surfaces where the hydrophilic end is closest to the water and the hydrophobic end is positioned away from the water surface and triggers substantially parallel mutually aligned ettringite rehydrate crystals.

8-13. (canceled)

14. A method of producing a masonry product comprising the steps of:
adding to a Portland cement an aggregate including expanded styrene beads and water, and a surfactant in liquid form at the time of mixing; then
mixing the mixture until the ingredients are distributed relatively uniformly through the mix and the quantity and character of aggregate is such that there can be a resultant density which will lie in the range of weight per cubic metre of 900 kg/cubic metre to 1500 kg/cubic metre.

15. The method of producing a masonry product as in claim 14, wherein the density of a final product after the mix has set and cured is approximately 1000 kg/m³.

16-18. (canceled)

19. The method as in claim 14, wherein the expanded polystyrene beads are within the weight range of 12 kg/m³ to 20 kg/m³, have a size of 2-6 mm in diameter and a Volume/m³ of 548 It to 913 It/m³.

20. The method as in claim 14, wherein water is added in the quantity of from 119 litres to 198 litres for each cubic metre of mix that is set and cured.

21. The method as in claim 14, wherein the surfactant is added in liquid form to the wet mixture in liquid form.

22. (canceled)

23. The method as in claim 14, wherein Calcium Chloride in the range from 0.1 to 4.7 litre per cubic metre of resultant mix is added to the wet mix.

24. A masonry product as in claim 1, wherein when in a form and being used as selected from any one of the following applications namely, a block, a tilt up panel, a roof or ceiling tile, a boat hull, a marine wall installation, and an integrated building structure including a floor, wall and roof.
